(19) United States
(12) Patent Application Publication
(10) Pub. No.: US 2010/0100294 A1
(43) Pub. Date: Apr. 22, 2010

(54) CONTROLLER FOR MULTIPLE DISK CLUTCH CONTROLLER, AND TRANSFER CASE

(76) Inventors: Kiyonori Hirao, Shizuoka (JP); Shingo Sugiyama, Shizuoka (JP); Yoshitaka Oonishi, Shizuoka (JP); Satoru Suzuki, Shizuoka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/449,457

(22) PCT Filed: Feb. 8, 2007
(86) PCT No.: PCT/JP2007/052272

§ 371 Date: Aug. 7, 2009

(51) Int. Cl. G06F 19/00

(52) U.S. Cl. 701/68

(57) ABSTRACT

PROBLEM

To provide a controller for a multiple disc clutch, and a transfer case each of which is capable of suppressing that a transmission torque of the multiple disc clutch shifts from expected one due to errors, and temperature changes in parts.

SOLVING MEANS

Including a multiple disc clutch 150 having a plurality of clutch plates 151, 152; a movement member 160 for contacting the multiple disc clutch 150 to adjust a connection force of the multiple disc clutch 150, the movement member 160 being movable in an arrangement direction of the plurality of clutch plates 151, 152; a motor 181 for moving the movement member 160 in the arrangement direction; a transmission mechanism 170 which transmits a driving force of the motor 181 to the movement member 160 and has a second cam plate 173 being subjected to a force in an arrangement direction in a phase of connection of the multiple disc clutch 150, and; a load detecting portion 190 for detecting the load exerted on the second cam plate 173; and an ECU for controlling the motor 181 in accordance with the load detected in the load detecting portion 190.

### TECHNICAL FIELD

The present invention relates to a controller for multiple disc clutch, and a transfer case.

### BACKGROUND ART

Heretofore, a motive power-transmitting mechanism for distributing a driving force of an engine to front wheels and rear wheels has been utilized in four-wheel drive vehicles. A motive power-transmitting mechanism including an input shaft to which a driving force of an engine is transmitted through a transmission or the like, a first output shaft for transmitting the driving force to rear wheels, and a second shaft for transmitting the driving force to front wheels, and also including a multiple disc clutch for adjusting a torque distribution between the first output shaft and the second output shaft is known as this sort of one (for example, refer to Patent literary document 1).

In a motive power-transmitting mechanism described in Patent literary document 1, a connection force of a multiple disc clutch is adjusted by a press plate which moves in an axial direction of a first output shaft. The press plate is driven by a motor through a conversion mechanism for converting a rotation displacement into an axial displacement. In this motive power-transmitting mechanism, a sensor for detecting the rotation displacement is provided in an output shaft of the motor, and a target position for the sensor is obtained from a torque to be transmitted by the multiple disc clutch in accordance with a characteristic curve which is previously determined from the elasticity of the conversion mechanism and the multiple disc clutch. Also, the motor is controlled in accordance with the resulting target position.

Patent literary document 1: Publication of the Translation of International Patent Application No. 2005-527741

### DISCLOSURE OF THE INVENTION

### Problem to be Solved by the Invention

However, in the motive power-transmitting mechanism described in Patent literary document 1, the elasticity of the conversion mechanism and the multiple disc clutch relatively, largely disperses due to size errors and assembly errors of the parts constituting the conversion mechanism, the parts disposed around the multiple disc clutch, and the like, and expansion, contraction and the like thereof due to the temperature change. As a result, there is encountered such a problem that the predetermined characteristic curve shifts from the actual characteristic curve, and the torque transmitted to the second shaft shifts from expected one.

In addition, when the torque transmitted to the second shaft shifts to become larger than the expected one, the loads applied to the respective parts increase. As a result, there is also caused such a problem that necessity to give each of the parts the sufficient strength and durability occurs in order to cope with this situation, and thus the parts become large in their sizes to increase their weights, thereby increasing the manufacturing cost.

In order to solve these problems, it is expected that the precisions of the parts increase, thereby reducing the shift of the characteristic curve. However, it is difficult to increase the precisions of all the constituent parts. Also, even when this is achieved, the manufacturing cost increases accordingly. In addition, it is also expected that after completion of the assembly of the parts, the characteristic curve inherent in the assembled conversion mechanism and multiple disc clutch is measured. However, such a control system becomes complicated, and thus the manufacturing cost increases.

The present invention has been made in the light of the above-mentioned circumstances, and it is therefore an object of the present invention to provide a controller and a transfer case for a multiple disc clutch, and a transfer each of which is capable of suppressing that a transmission torque of the multiple disc clutch shifts from expected one due to errors, and temperature changes in parts.

### Means for Solving Problem

In order to attain the above-mentioned object, there is provided a controller for a multiple disc clutch, including:
a multiple disc clutch having a plurality of clutch plates;
a movement member for contacting the multiple disc clutch to adjust a connection force of the multiple disc clutch, the movement member being movable in an arrangement direction of the plurality of clutch plates;
a driving portion for moving the movement member in the arrangement direction;
a transmission portion which transmits a driving force of the driving portion to the movement member, is subjected to a force in the arrangement direction in a phase of connection of the multiple disc clutch, and has a loaded member being subjected to a load linear with respect to the connection force of the multiple disc clutch in a predetermined direction;
a load detecting portion for detecting the load exerted on the loaded member in the predetermined direction; and
a control portion for controlling the driving portion in accordance with the load detected in the load detecting portion.

In addition, in order to attain the above-mentioned object, there is provided a controller for a multiple disc clutch, including:
a multiple disc clutch having a plurality of clutch plates;
a movement member for contacting the multiple disc clutch to adjust a connection force of the multiple disc clutch, the movement member being movable in an arrangement direction of the plurality of clutch plates, the movement member being movable to a position where the movement member is separated apart from the multiple disc clutch;
a driving portion for moving the movement member in the arrangement direction;
a transmission portion which transmits a driving force of the driving portion to the movement member, is subjected to a force in the arrangement direction in a phase of connection of the multiple disc clutch, and has a loaded member being subjected to a load linear with respect to the connection force of the multiple disc clutch in a predetermined direction;
a displacement detecting portion for detecting a displacement of a link member, the link member being moved by driving of the driving portion;
a load detecting portion for detecting a load exerted on the member on which a load is to be exerted in a predetermined direction; and
a control portion for controlling the driving portion in accordance with the load detected in the load detecting portion with respect to a position where the movement member contacts the multiple disc clutch, and controlling the driving portion in accordance with the displacement detected in the displacement detecting portion with respect to a position where the movement member is separated apart from the multiple disc clutch.

Also, in order to attain the above-mentioned object, there is provided a transfer case, including:
an input shaft;
a first output shaft and a second shaft, a motive power of the input shaft being transmitted to each of the first output shaft and the second shaft; and
a controller, for the above-mentioned multiple disc clutch, for controlling a distribution of the motive power transmitted from the first input shaft to each of the first output shaft and the second output shaft.

### EFFECTS OF THE INVENTION

According to the present invention, it is possible to suppress that a transmission torque of the multiple disc clutch shifts from expected one due to errors and temperature changes in parts.

### BRIEF DESCRIPTION OF THE DRAWINGS

FIG. 1 A schematic explanatory view of a four-wheel drive vehicle showing a first embodiment of the present invention.

FIG. 2 A schematic cross sectional view of a transfer case.

FIG. 3 A partially enlarged cross sectional view of the transfer case.

FIG. 4 A schematic explanatory front view of a first cam plate and a second cam plate, and parts relating thereto.

FIG. 5 An enlarged view of the vicinities of grooves of the first cam plate and the second cam plate.

FIG. 6A An explanatory cross sectional view of a load detecting portion.

FIG. 6B A graph showing a relationship between a connection force of a multiple disc clutch, and a load exerted on the first cam plate and detected in the load detecting portion.

FIG. 7 An explanatory view showing a state in which the first cam plate moves to the other circumferential side most to abut against a regulated member which is not shown.

FIG. 8 An explanatory view showing a position of the first cam plate in a state in which a movement member contacts the multiple disc clutch without generating a connection force in the multiple disc clutch.

FIG. 9 An explanatory view showing a state in which the first cam plate moves to one circumferential side most.

FIG. 10 A graphical representation showing a relationship between a rotation displacement of an output shaft of a motor, and a load detected in the load detecting portion.

FIG. 11 A schematic block diagram of an ECU of the transfer case.

FIG. 12A A graphical representation showing a relationship between a pulse count in a pulse sensor of the motor, and the load detected in the load detecting portion.

FIG. 12B A graphical representation showing a relationship between the pulse count in the pulse sensor of the motor, and a false signal generated in a feedback signal-generating portion.

FIG. 12C A graphical representation showing a relationship between the pulse count in the pulse sensor of the motor, and a load represented by a feedback signal outputted from the feedback signal-generating portion.

FIG. 13 A flow chart showing control for the transfer case made by the ECU.

FIG. 14 An explanatory cross sectional view, of a load detecting portion of a change of the first embodiment, showing a state in which positions of a piston and a rod shift due to a temperature change.

FIG. 15 A graphical representation showing the change of the first embodiment, showing a state in which a reference position of the pulse sensor is proofread in accordance with a temperature change, and showing a relationship between the pulse count in the pulse sensor of the motor, and the detected load.

FIG. 16 A graphical representation showing a second embodiment of the present invention, and showing a relationship between a rotation displacement of an output shaft of a motor, and a load detected in a load detecting portion in a transfer case installed in a vehicle in which two modes having a 4WD auto mode and a 4WD lock mode can be switched over to each other.

FIG. 17 A schematic block diagram of an ECU of the transfer case.

FIG. 18 A partial explanatory cross sectional view, of a transfer case, showing a third embodiment of the present invention.

FIG. 19 A front view of a lever member.

FIG. 20 A schematic explanatory front view, of a first cam plate and a second cam plate, and parts relating thereto, showing a fourth embodiment of the present invention, and showing a positional relationship among the parts in a multiple disc clearance region.

FIG. 21 A schematic explanatory front view, of the first cam plate and the second cam plate, and the parts relating thereto, showing a positional relationship among the parts in a torque control region.

FIG. 22 A graphical representation in which its upper side is a graphical representation showing a relationship between a rotation displacement of the first cam plate, and a load detected in a load detecting portion, and its lower side is a graphical representation showing a relationship between the rotation displacement of the first cam plate, and a rotation displacement of an output shaft of a motor.

### DESCRIPTION OF REFERENCE NUMERALS

1 automobile vehicle

2 engine

3 transmission

4 center drive shaft

5 transfer case

6 front drive shaft

7 rear drive shaft

8 front differential

9 front wheel

10 rear differential

11 rear wheel

12 ECU

13 operation switch

14 speed sensor

15 acceleration sensor

16 front wheel rotation sensor

17 rear wheel rotation sensor

18 throttle sensor

19 engine revolution sensor

20 steering angle sensor

100 case

110 input shaft

111 ball bearing

120 output shaft for rear wheels

121 ball bearing

122 sprocket

130 output shaft for front wheels

131 ball bearing

132 sprocket

140 chain

150 multiple disc clutch

151 driving plate

152 driven plate

153 clutch hub

154 clutch drum

155 return spring

160 movement member

170 transmission mechanism

171 pinion gear

172 first cam plate

172a ring portion

172b driven portion

172c thrust needle bearing

172d groove portion

173 second cam plate

173a ring portion

173b regulated portion

173c thrust needle bearing

173d groove portion

174 ball

180 actuator

181 motor

181a output shaft

182 reduction gear set

182a output shaft

183 bracket

184 pulse sensor

190 load detecting portion

191 cylinder

192 piston

193 rod

194 pressure sensor

195 seal member

201 mode inputting portion

202 vehicle state-inputting portion

203 torque determining portion

204 load arithmetically operating portion

205 current arithmetically operating portion

206 current outputting portion

207 memory portion

208 load inputting portion

209 displacement inputting portion

210 feedback signal-generating portion

211 load proofreading portion

371 lever member

371a insertion hole

371b protrusion portion

371c reception hole

372 thrust needle bearing

380 linear actuator

381 rod

390 load sensor

391 rod

470 transmission mechanism

471 cam member

472e cam follower

### BEST MODE FOR CARRYING OUT THE INVENTION

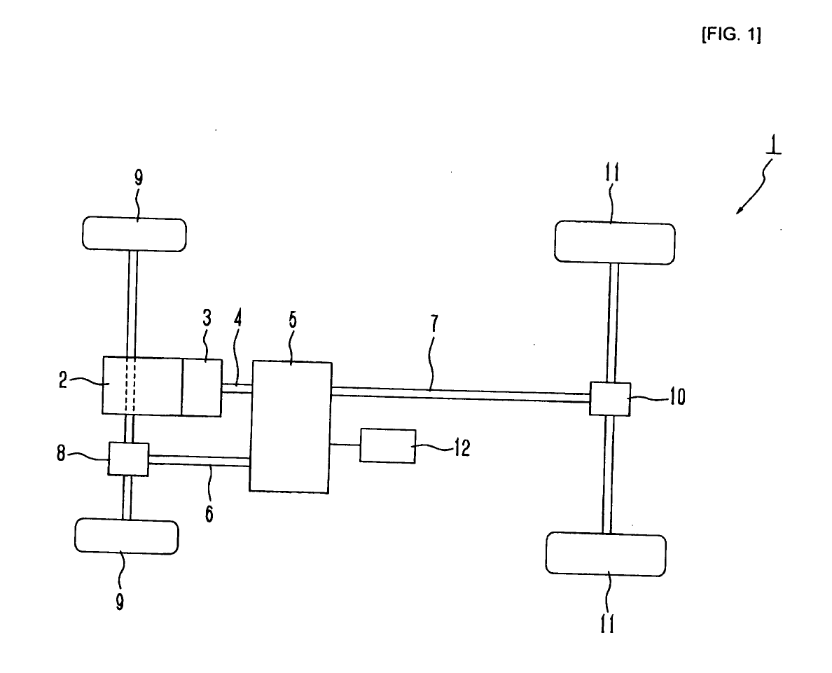

FIG. 1 is a schematic explanatory view of a four-wheel drive vehicle showing a first embodiment of the present invention.

As shown in FIG. 1, the automobile 1 includes an engine 2 serving as a prime bar, a transmission 3 for performing a gear change operation, a center drive shaft 4 to which a driving force of the engine 2 is transmitted through the transmission 3, a transfer case 5 which serves as a motive power-transmitting device and to which a driving force of the center drive shaft 4 is inputted, and a front drive shaft 6 and a rear drive shaft 7 to which a driving force of the center drive shaft 4 is outputted from the transfer case 5 at a predetermined distribution ratio. A driving force of the front drive shaft 6 is transmitted to a pair of left and right front wheels 9 through a front differential 8. A driving force of the rear drive shaft 7 is transmitted to a pair of left and right rear wheels 11 through a rear differential 10.

The ratio at which the driving force is distributed between the front drive shaft 6 and the rear drive shaft 7 in the transfer case 5 is determined by an electronic control unit (ECU) 12. The ECU 12 performs control for the transfer case 5 in accordance with a mode data on which is inputted through a manipulation switch 13 manipulated by a crew of the automobile vehicle 1. In this embodiment, any one of three modes having a 2WD mode, a 4WD auto mode, and a 4WD lock mode can be selected. When the 2WD mode is selected by manipulating the manipulation switch 13, the ECU 12 controls the transfer case 5 so that all the driving forces are transmitted to the rear drive shaft 7, while none of the driving forces are transmitted to the front drive shaft 6. In addition, when the 4WD lock mode is selected by manipulating the manipulation switch 13, the ECU 12 controls the transfer case 5 so that the driving force is transmitted at the distribution ratio of 50:50 to the front drive shaft 6 and the rear drive shaft 7.

In addition, the ECU 12 is connected to a speed sensor 14 for detecting a speed of the vehicle, an acceleration sensor 15 for detecting a transverse acceleration of the vehicle, a front wheel rotation sensor 16 and a rear wheel rotation sensor 17 for detecting the numbers of rotations of each of the front wheels 9 and each of the rear wheels 11, respectively, a throttle sensor 18 for detecting the degree of opening of a throttle in the engine 2, an engine revolution sensor 19 for detecting the number of revolutions of the engine 2, a rudder angle sensor 20 for detecting a rudder angle of a steering, and the like. Also, when the 4WD auto mode is selected by manipulating the manipulation switch 13, the ECU 12 adjusts a distribution at which the driving force transmitted to the drive shafts 6 and 7 in correspondence to states of the vehicle such as the speed of the vehicle, the transverse acceleration, the rotation ratio between the front and the rear wheels, the degree of opening of the throttle, and the number of revolutions of the engine.

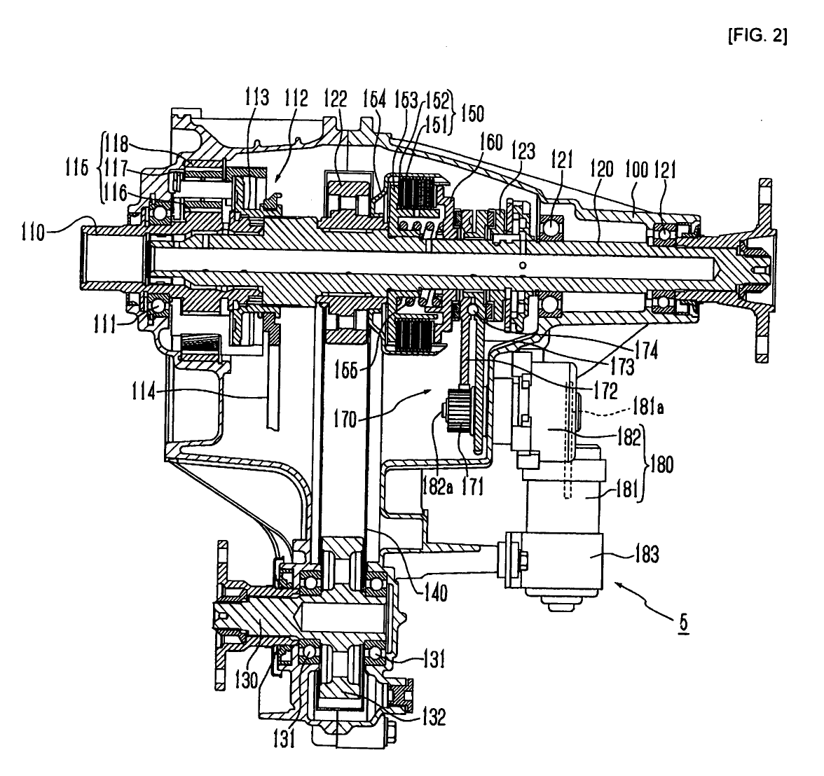

FIG. 2 is a schematic cross sectional view of the transfer case.

As shown in FIG. 2, the transfer case 5 includes an input shaft 110 which rotates together with the center drive shaft 4, an output shaft 120 for rear wheels which serves as a first output shaft and which is connected to the rear drive shaft 7, and an output shaft 130 for front wheels which serves as a second output shaft and which is connected to the front drive shaft 6. The input shaft 110, the output shaft 120 for rear wheels, and the output shaft 130 for front wheels are supported by ball bearings 111, 121 and 131, respectively, so as to be rotatable with respect to a case 100.

A driving force of the input shaft 110 is transmitted to the output shaft 120 for rear wheels through a reduction gear 112. The reduction gear 112 has a slide gear 113 with which the driving force transmitted to the output shaft 120 for rear wheels is switched in two steps for a low speed and a high speed, and a switching fork 114 which moves the slide gear 113 and which is driven by a motor (not shown). Here, a part of the fork 114 is omitted together with the motor or the like in its illustration from the reason of avoiding the complicated figure. The reduction gear 112 has a planetary gear mechanism 115 for reducing the driving force of the input shaft 110, and transmitting the resulting driving force to the output shaft 120 for rear wheels. The planetary gear mechanism 115 has a sun gear 116 which is formed in the input shaft 110, a pinion gear 117 which meshes with the sun gear 116, a ring gear 118 which meshes with the pinion gear 117 and which is disposed concentrically with the sun gear 116, a carrier which supports the pinion gear 117. The slide gear 113 is constructed so that it is normally engaged with the output shaft 120 for rear wheels, and is selectively engaged with either the input shaft 110 or the carrier.

The input shaft 110 and the output shaft 120 for rear wheels are coaxially disposed in a line on a front side and a rear side, respectively. A sprocket 122 which is rotatable with respect to the output shaft 120 for rear wheels, and a regulation member 123 which is disposed at a distance from the sprocket 122 are radially provided outside the output shaft 120 for rear wheels. In addition, a sprocket 132 is fixedly fastened to an outer periphery of the output shaft 130 for front wheels. A chain 140 is wound around each of the sprockets 122 and 132. Thus, when the driving force is transmitted from the output shaft 120 for rear wheels to the sprocket 122, the output shaft 130 for front wheels is driven through the chain 140.

In addition, the transfer case 5 includes a multiple disc clutch 150 through which the output shaft 120 for rear wheels and the output shaft 130 for front wheels are dynamically connected to each other, and a movement member 160 for performing depressing and release of the multiple disc clutch 150. The multiple disc clutch 150 has driving plates 151 and driven plates 152 which serve as a plurality of clutch plates and which perform transmission of a driving torque by the mutual surface contact between them. Each of the driving plates 151 is supported by a clutch hub 153 so as to be axially movable, and each of the driven plates 152 is supported by a clutch drum 154 so as to be axially movable. The clutch hub 153 is fixedly fastened to an outer peripheral surface of the output shaft 120 for rear wheels, and the clutch drum 154 is fixedly fastened to an axial rear side of the sprocket 122.

The movement member 160 is installed on a side axially opposite to the sprocket 122 of the multiple disc clutch 150, and thus is movable in an arrangement direction of the driving plates 151 and the driven plates 152. The movement member 160 adjusts a fastening force for the multiple disc clutch 150 by depressing the multiple disc clutch 150. In this embodiment, the arrangement direction of the driving plates 151 and the driven plates 152 agrees with an axial direction of the output shaft 120 for rear wheels. The movement member 160 is moved through a transmission mechanism 170 for converting a rotary motion into an axial motion by driving of an actuator 180. In addition, the movement member 160 is backward biased by a return spring 155 provided between the clutch hub 153 and the movement member 160.

The transmission mechanism 170 transmits the driving force of the actuator 180 to the movement member 160. The actuator 180 includes a motor 181 having an output shaft 181a, and a reduction gear set 182 for reducing an output of the motor 181. The motor 181 is fixedly fastened to the case 100 through a bracket 183. The transmission mechanism 170 has a pinion gear 171 which is connected to an output shaft 182a of the reduction gear set 182, a first cam plate 172 which meshes with the pinion gear 171, a second cam plate 173 which is disposed so as to face the first cam plate 172, and a ball 174 which is interposed between the first cam plate 172 and the second cam plate 173. In this embodiment, the output shaft 182a of the reduction gear set 182 constitutes an output shaft of the actuator 180. In a phase of connection of the multiple disc clutch 150, an axial force is applied to each of the first cam plate 172 and the second cam plate 173.

The motor 181 of the actuator 180 is controlled in its current in accordance with a signal outputted from the ECU 12. In addition, the reduction gear set 182 is constituted by a warm gear. The output shaft 181a of the motor 181 and the output shaft 182a of the reduction gear set 182 are held by cutting off a current being caused to flow through the motor 181. Here, a high efficient gear may be used as the reduction gear set 182 instead of using the warm gear, and also a brake for holding a rotation position of the output shaft 181a of the motor 181 may be used. The output shaft 181a which serves as a link member and which is moved by driving of the motor 181 rotates the first cam plate 172 through the reduction gear set 182 and the pinion gear 171. In addition, the motor 181 is provided with a pulse sensor 184 which serves as a displacement detecting portion and which detects a rotation displacement of the output shaft 181a. Note that, in addition to the construction with which the displacement of the output shaft 181a of the motor 181 is detected, a construction is also expected with which a displacement of the output shaft 182a of the reduction gear set 182 is detected. The link member a displacement of which is detected by the displacement detecting portion may be a member constituting the actuator 180, or may be a member constituting the transmission mechanism 170. In brief, any of suitable members may be used as the link member as long as it moves in the phase of driving of the actuator 180.

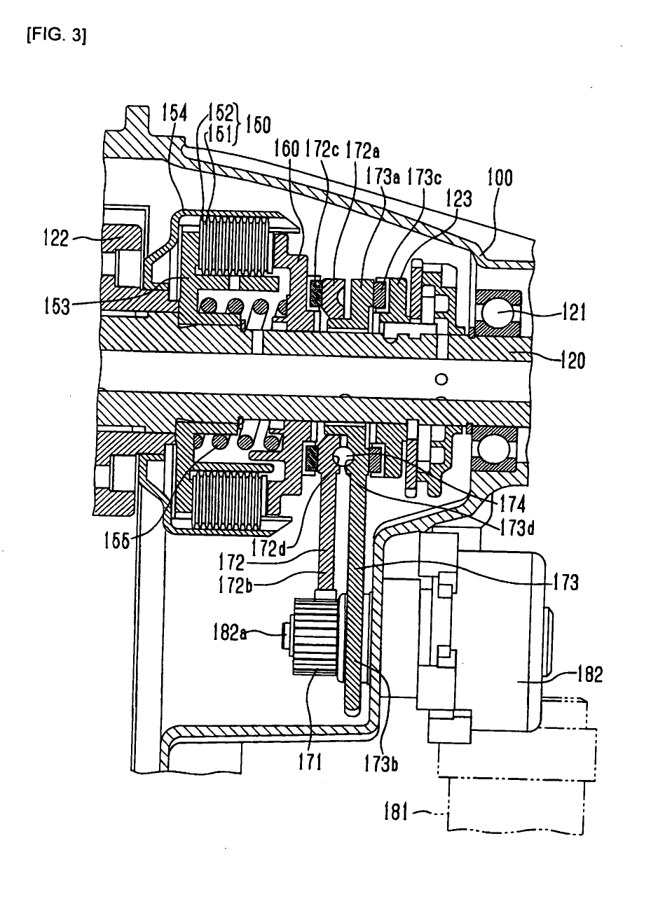

FIG. 3 is a partially enlarged cross sectional view of the transfer case.

As shown in FIG. 3, the first cam plate 172 has a ring portion 172a which is rotatably mounted to the output shaft 120 for rear wheels, and a driven portion 172b which radially extends outward from the ring portion 172a to mesh with the pinion gear 171. As shown in FIG. 3, the first cam plate 172 as an intermediate member is provided between the second cam plate 173 and the movement member 160. In this embodiment, the driving force of the actuator 180 is reduced and in this state is transmitted from the pinion gear 171 to the driven portion 172b. In addition, the second cam plate 173 as a member on which a load is to be exerted has a ring member 173a which is rotatably mounted to the output shaft 120 for rear wheels, and a regulated portion 173b which radially extends outward from the ring portion 173a, and which is regulated in one circumferential rotation thereof with a predetermined backlash and is regulated in the other circumferential rotation thereof by a stopper (not shown).

In addition, the ring portion 172a of the first cam plate 172 has a thrust needle bearing 172c as an abutment portion which is formed in a front surface and which abuts against the movement member 160, and a groove portion 172d which is formed in a rear surface and in which a front side of a ball 174 is accommodated. The ring member 172a is provided so as to be rotatable and axially movable with respect to the output shaft 120 for rear wheels.

The ring portion 173a of the second cam plate 173 has a thrust needle bearing 173a as an abutment portion which is formed in a rear surface and which abuts against the regulation member 123, and a groove portion 173d which is formed in a front face and in which a rear side of the ball 174 is accommodated. That is to say, the ball 174 is held between the groove portions 172d and 173d of the first and second cam plates 172 and 173. The ring portion 173a is provided so as to be rotatable and axially movable with respect to the output shaft 120 for rear wheels, and its rotational movement is regulated with a predetermined backlash by a load detecting portion 190 and its axial movement is regulated by the regulation member 123.

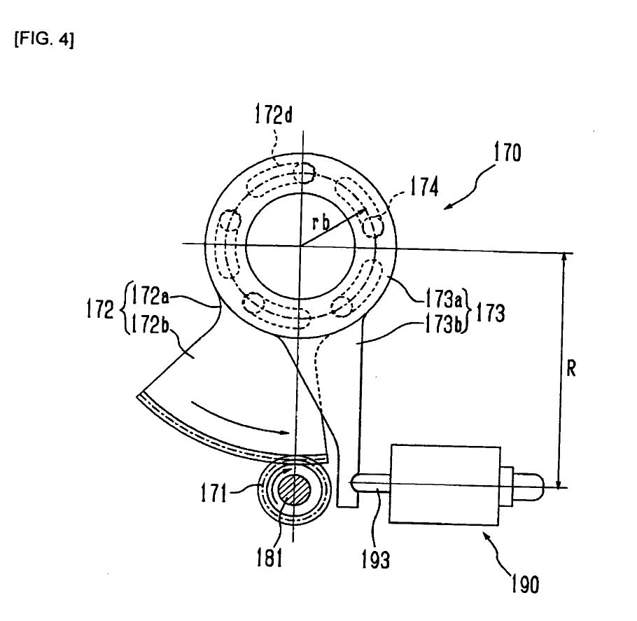

FIG. 4 is a schematic explanatory front view of the first cam plate and the second cam plate, and parts relating thereto.

As shown in FIG. 4, in this embodiment, the five grooves 172d, the five grooves 173d, and the five balls 174 are each circumferentially disposed at predetermined intervals. The grooves 172d and the grooves 173d are each formed at a distance rb from a center of the output shaft 120 for rear wheels so as to circumferentially extend by a predetermined section. Here, the number of grooves 172d, the number of grooves 173d, and the number of balls 174 can be suitably changed.

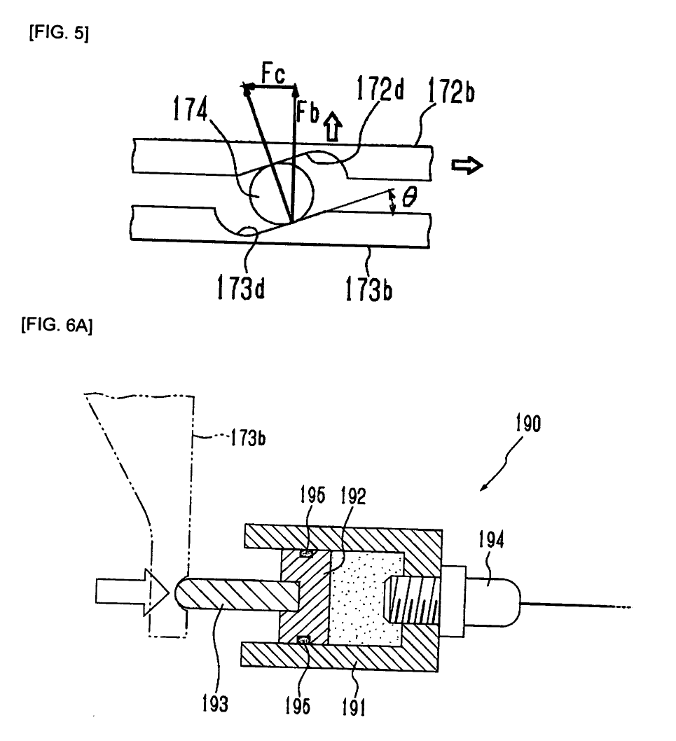

FIG. 5 is an enlarged explanatory view of the vicinities of the grooves of the first cam plate and the second cam plate.

As shown in FIG. 5, each of the grooves 172d is formed so as to deepen at a given rate in the other circumferential direction. In addition, each of the grooves 173d is formed so as to deepen at a given rate in one circumferential direction. As a result, when the first cam plate 172 rotates in the one circumferential direction in a state in which the rotation of the second cam plate 173 in the one circumferential direction is regulated, the ball 174 rolls on the surface of the groove 172d and the surface of the groove 173d from the deeper portions to the shallower portions of the groove 172d and the groove 173d, so that the first cam plate 172 is separated apart from the second cam plate 173. On the other hand, when the first cam plate 172 moves in the other circumferential direction, the ball 174 rolls on the surface of the groove 172d and the surface of the groove 173d from the shallower portions to the deeper portions of the groove 172d and the groove 173d, so that the first cam plate 172 comes close to the second cam plate 173. When the ball 174 is located in the middle of the grooves 172d and 173d, an axial reaction force Fb and a circumferential reaction force Fc proportional thereto are exerted on the second cam plate 173. Consequently, the load detecting portion 190 detects a load which is linear with respect to the axial reaction force Fb.

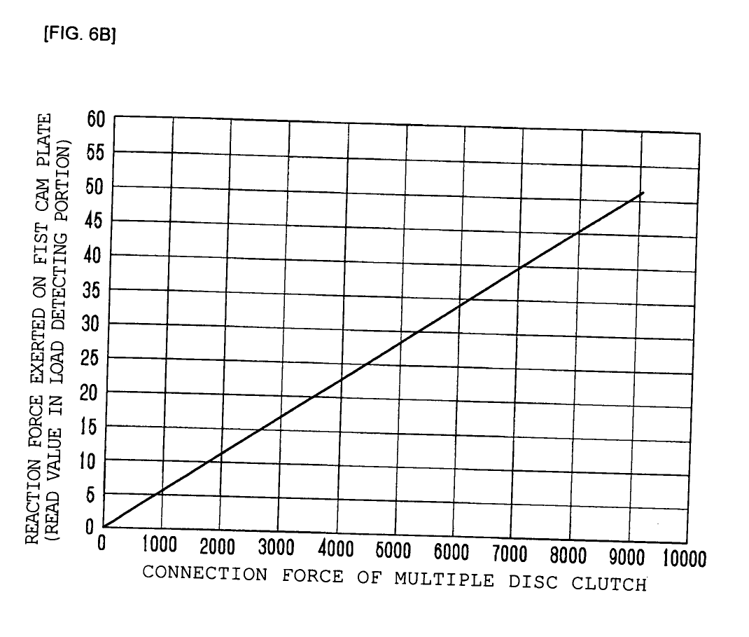

The load detecting portion 190 detects a load which is exerted in the one circumferential direction on the second cam plate 173 in a position located at a distance R from the center of the output shaft 120 for rear wheels (refer to FIG. 4). That is to say, the load detecting portion 190 detects the load expressed by Fc×R/rb, and the load which is linear with respect to a connection force of the multiple disc clutch 150 is outputted from the second cam plate 173. FIG. 6A is an explanatory cross sectional view of the load detecting portion. As shown in FIG. 6A, the load detecting portion 190 has a cylinder 191 in which oil is filled as fluid, a piston 192 which can move inside the cylinder 191, a rod 193 which is coupled to the piston 192, and a seal member 195. A head of the rod 193 abuts against the regulated portion 173b of the second cam plate 173 with the connection force being generated in the multiple disc clutch 150. Also, when one circumferential force is applied to the second cam plate 173 in a state in which the rod 193 abuts against the second cam plate 173, the rod 193 moves within the cylinder 191, so that an oil pressure within the cylinder 191 increases. That is to say, the cylinder 191, the piston 192 and the rod 193 constitute a conversion mechanism for converting a load into an oil pressure. Also, the cylinder 191 is provided with a pressure sensor 194 for detecting an oil pressure, and converting the oil pressure into an electrical signal. The electrical signal outputted from the pressure sensor 194 is detected by the ECU 12. Here, the load detecting portion 190 may use a load sensor for directly detecting a load without using the oil pressure. Thus, the construction with which a load is detected is arbitrarily made. The load sensor stated herein, for example, means one for outputting an electrical signal proportional to a load by using a strain gauge or the like.

FIG. 6B is a graph showing a relationship between the connection force of the multiple disc clutch, and the load which is exerted on the second cam plate and which is detected by the load detecting portion. As shown in FIG. 6B, the load which is linear with respect to the connection force of the multiple disc clutch 150 is exerted in the rotation direction on the second cam plate 173.

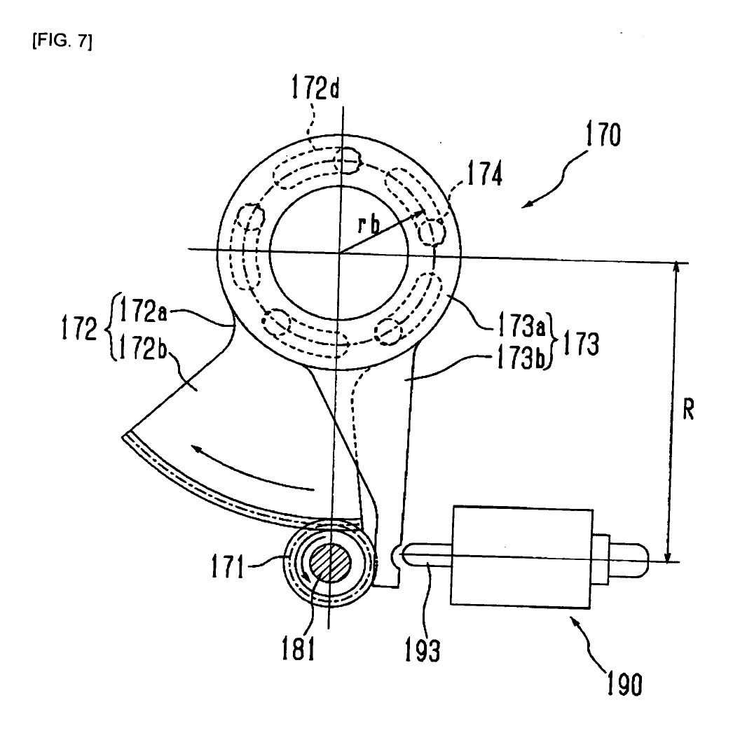

Here, states of the conversion mechanism, the movement member and the multiple disc clutch in the movable range of the first cam plate 172 will now be described with reference to FIG. 4 and FIGS. 7 to 9. FIG. 7 is an explanatory view showing a state in which the first cam plate moves to the other circumferential side most to abut against the regulated member (not shown).

As shown in FIG. 7, in the state in which the first cam plate 172 moves to the other circumferential side most, the movement member 160 and the first cam plate 172 are pressed against the second cam plate 173 side by an biasing force of the return spring 155. At this time, no circumferential load is exerted on the second cam plate 172 because the second cam plate 172 is separated apart from the load detecting portion 190.

When the first cam plate 172 moves in one circumferential direction from the state of FIG. 7, as shown in FIG. 4, the second cam plate 173 moves together with the first cam plate 172 in the one circumferential direction to contact the load detecting portion 190.

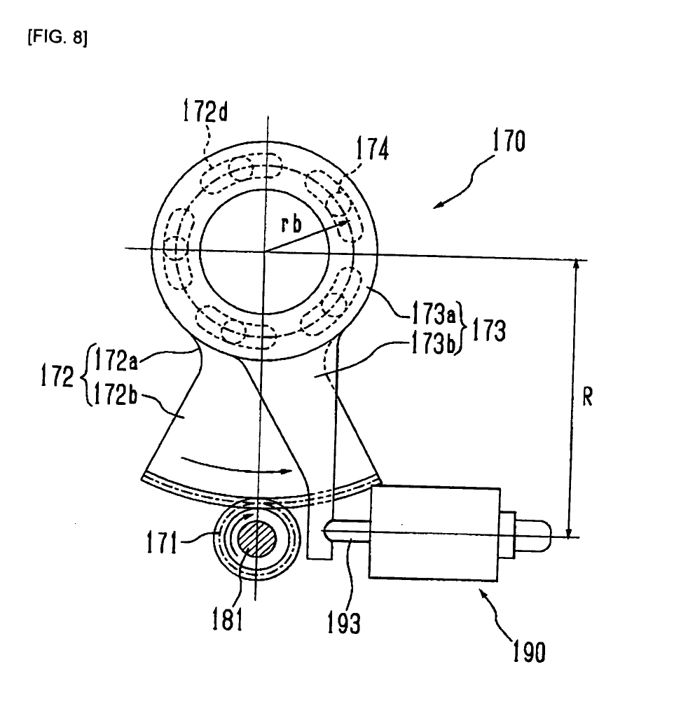

When the first cam plate 172 moves in the one circumferential direction from the state of FIG. 4, the first cam plate 172 rotates relatively with respect to the second cam plate 173 since the movement of the second cam plate 173 is regulated by the load detecting portion 190. At this time, since the first cam plate 172 is separated apart from the second cam plate 173, the movement member 160 moves to a multiple disc clutch 150 side against the biasing force of the return spring 155, and abuts against the multiple disc clutch 150 in a short time. FIG. 8 shows a position of the first cam plate 172 in a state in which the movement member 160 contacts the multiple disc clutch 150 without generating the connection force in the multiple disc clutch 150.

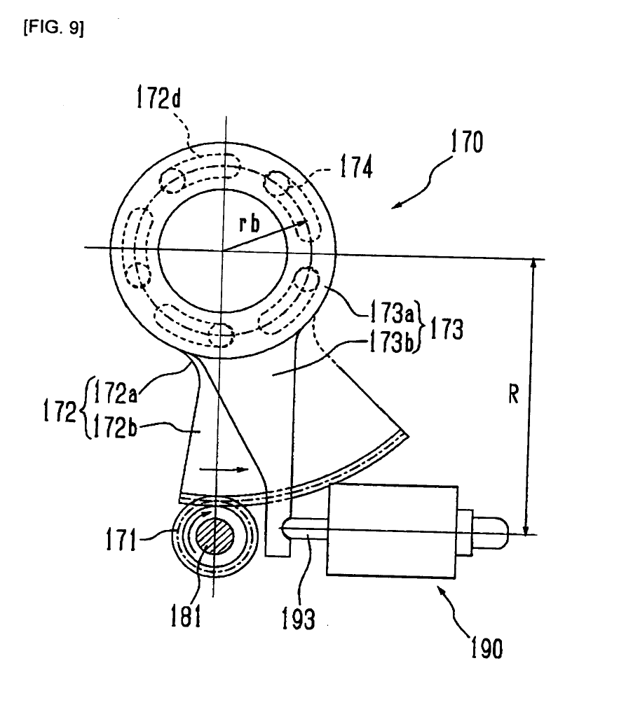

When the first cam plate 172 moves in the one circumferential direction from the state of FIG. 8, the movement member 160 moves in a direction of compressing each of the plates 151 and 152 of the multiple disc clutch 150 against an elastic force of the multiple disc clutch 150 as well as against the biasing force of the return spring 155. Also, as shown in FIG. 9, the connection force of the multiple disc clutch 150 becomes maximum in a state in which the first cam plate 172 moves to the one circumferential direction side most.

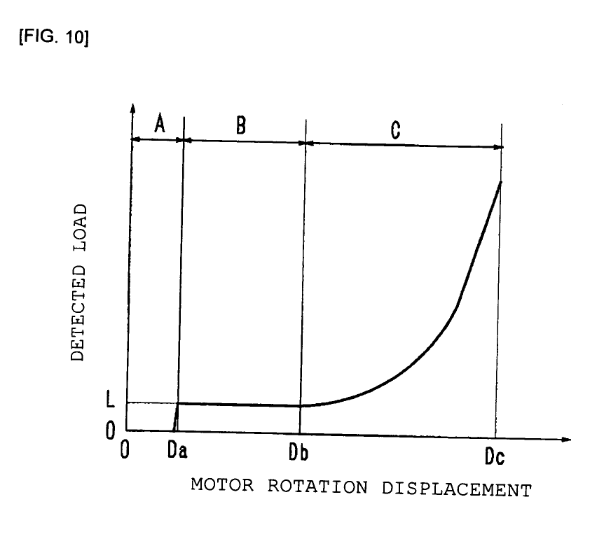

Next, a relationship between the rotation displacement of the output shaft 181a of the motor 181 for driving the first cam plate 172, and the load exerted on the second cam plate 173 and detected in the load detecting portion 190 will now be described with reference to FIG. 10. FIG. 10 is a graphical representation showing a relationship between the rotation displacement of the output shaft of the motor, and the load detected in the load detecting portion. This graph illustrates each of the rotation displacement of the output shaft 181a and load detected in the load detecting portion 190 as zero in the state in which the first cam plate 172 as shown in FIG. 7 moves to the other circumferential direction most.

As shown in FIG. 10, even when the rotation displacement of the output shaft 181a increases, the load is held as zero until the second cam plate 173 comes to contact the load detecting portion 190 from a state in which the rotation displacement is zero. Here, a region in which the output shaft 181a can be rotated without causing the second cam plate 173 to contact the load detecting portion 190 is referred to as a sensor clearance region A.

When the second cam plate 173 contacts the load detecting portion 190 as shown in FIG. 4, the load detected in the load detecting portion 190 abruptly increases due to the biasing force of the return spring 155. In FIG. 10, the rotation displacement at this time is indicated as Da. Also, even when the rotation displacement of the output shaft 181a increases, the detected load hardly changes until the movement member 160 comes to contact the multiple disc clutch 150 as shown in FIG. 8. Strictly speaking, the load slightly increases since the return spring 155 is compressed along with the movement of the movement member 160. However, an increase in load is negligibly small as compared with that in load detected in the phase of connection of the multiple disc clutch 150. Here, a region in which the output shaft 181a can be rotated so as to move the movement member 160 without generating the connection force in the multiple disc clutch 150 is referred to as a multiple disc clearance region B. In addition, the load detected in the load detecting portion 190 at this time is indicated as a reference load L.

When the movement member 160 contacts the multiple disc clutch 150 as shown in FIG. 8, the load detected in the load detecting portion 190 increases from the reference load L due to the connection force of the multiple disc clutch 150. In FIG. 10, the rotation displacement at which the movement member 160 contacts the multiple disc clutch 150 is indicated as Db. When the connection force is generated in the multiple disc clutch 150, the rotation displacement of the output shaft 181a and the detected load do not show a proportional relationship owing to the elasticity of the multiple disc clutch 150, the transmission mechanism 170 and the like. A region in which the connection force is generated in the multiple disc clutch 150 in such a manner is referred to as a torque control region C. In FIG. 10, the rotation displacement at which the connection force of the multiple disc clutch 150 becomes maximum is indicated as Dc.

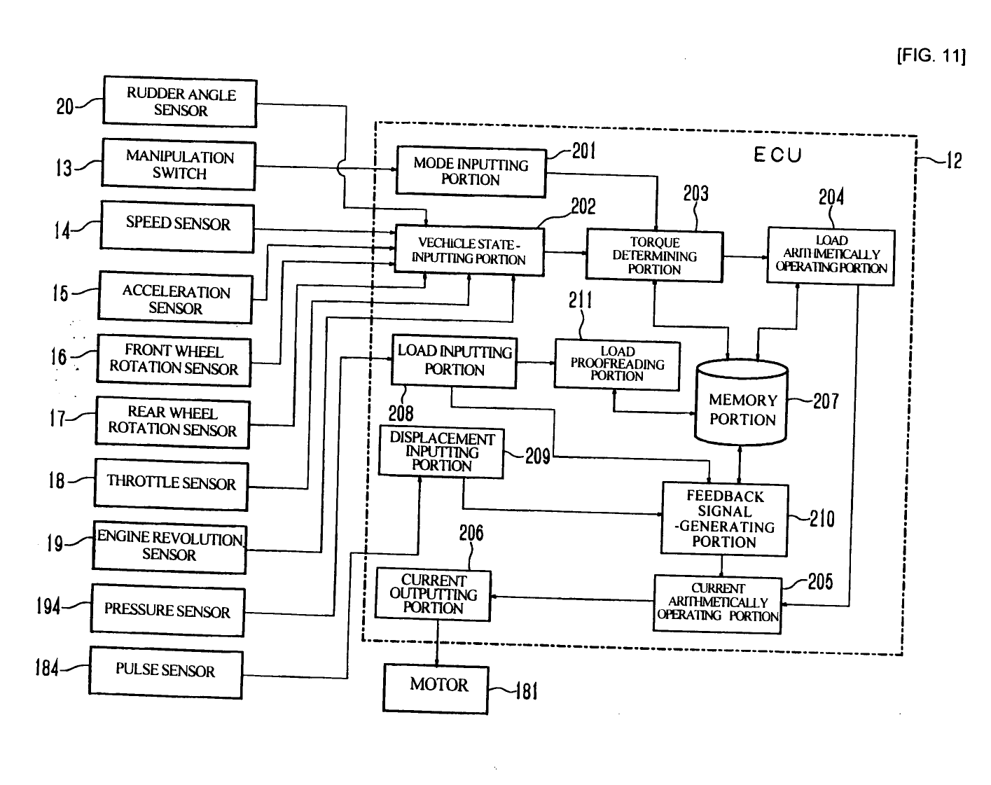

Subsequently, the ECU 12 will now be described with reference to FIG. 11. Here, in FIG. 11, a reduction gear mechanism-shifting portion is omitted in its illustration. FIG. 11 is a schematic block diagram of the ECU of the transfer case.

As shown in FIG. 11, the ECU 12 serving as the control portion has a mode inputting portion 201 to which a signal is inputted through the operation switch 13, a vehicle state-inputting portion 202 to which signals are inputted from the speed sensor 14, the acceleration sensor 15, the front wheel rotation sensor 16, the rear wheel rotation sensor 17, the throttle sensor 18, the engine revolution sensor 19, steering angle sensor 20, and the like, respectively, and a torque determining portion 203 for determining a target torque which is distributed to the front drive shaft 6 in accordance with the signals inputted to the mode inputting portion 201 and the vehicle state-inputting portion 202, respectively. In addition, the ECU 12 has a load arithmetically operating portion 204 for arithmetically operating a pressure which is applied to the pressure sensor 194 and which corresponds to the target torque determined in the torque determining portion 203, a current arithmetically operating portion 205 for arithmetically operating a current which is caused to flow through the motor 181 so as to obtain the pressure arithmetically operated in the load arithmetically operating portion 204, and a current outputting portion 206 for outputting a signal relating to the current arithmetically operated in the current arithmetically operating portion 205 to the motor 181.

In this embodiment, the current outputting portion 206 controls the motor 181 in accordance with a pulse width modulation (PWM) system. The ECU 12 controls the motor 181 in accordance with the load detected in the load detecting portion 190.

As shown in FIG. 11, the ECU 12 has a memory portion 207 in which data on the target torque distributed to the front drive shaft 6 in each of the modes having the 2WD mode, the 4WD auto mode, and the 4WD lock mode is stored. In the case of the 2WD mode, the target torque is set so that the connection force of the multiple disc clutch 150 becomes minimum with the displacement of the output shaft 181a of the motor 181 being fixed to zero. In the case of the 4WD lock mode, the target torque is set so that the connection force of the multiple disc clutch 150 becomes maximum with the displacement of the output shaft 181a of the motor 181 being fixed to zero. Also, in the case of the 4WD auto mode, the target torque is set so that the connection force of the multiple disc clutch 150 change in accordance with the vehicle state. A map which is utilized in the case of the 4WD auto mode, and in which the speed of the vehicle, the transverse acceleration, the ratio in rotation between the front wheels and the rear wheels, the degree of opening of the throttle, the number of revolution of the engine, the angle of the steering, and the like are made to correspond to the target torque is stored in the memory portion 207.

In addition, a map in which the pressure applied to the pressure sensor 194 is made to correspond to the target torque is stored in the memory portion 207. Here, if the proportional relationship is established between the target torque and the pressure, only a proportional coefficient relating thereto may be stored in the memory portion 207. Moreover, data on the pressure which is applied to the pressure sensor 194 and which corresponds to the above-mentioned reference load L is stored in the memory portion 207.

Moreover, the ECU 12 has a load inputting portion 208 to which the signal is inputted from the pressure sensor 194 in the load detecting portion 190, a displacement inputting portion 209 to which the signal is inputted from the pulse sensor 184 of the motor 181, and a feedback signal-generating portion 210 for generating a feedback signal in accordance with signals inputted thereto from the load inputting portion 208 and the displacement inputting portion 209, respectively. In this embodiment, the current arithmetically operating portion 206 performs the arithmetic operations about three elements having a deviation between a pressure value outputted from the feedback signal-generating portion 210 and the pressure value inputted thereto as a target value from the load arithmetically operating portion 204, an integration thereof, and a differential thereof. That is to say, the current arithmetically operating portion 206 performs proportional integral derivative (PID) control as the feedback control.

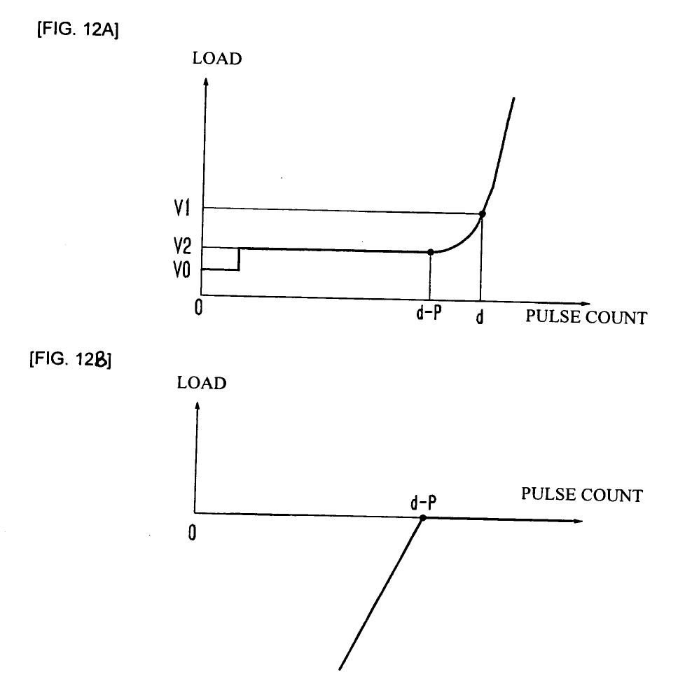

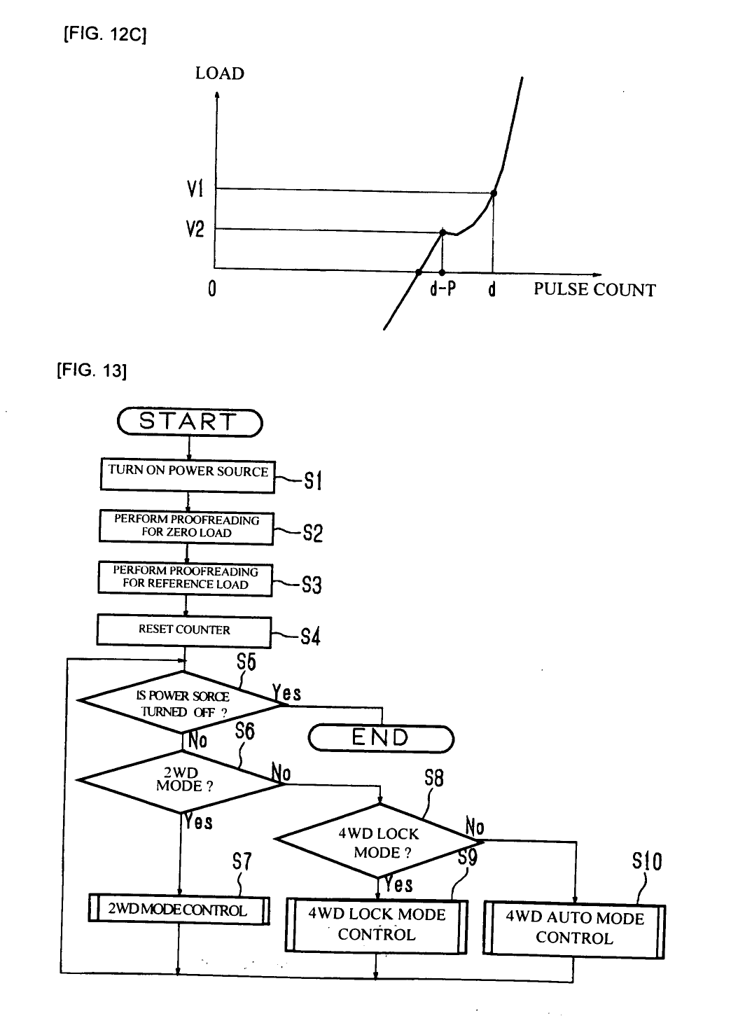

The feedback signal-generating portion 210 corrects a pressure value which is detected in the pressure sensor 194 and which is inputted thereto from the load inputting portion 208 in accordance with the rotation displacement the data on which is inputted thereto from the displacement inputting portion 209, thereby generating the feedback signal. The generation of the feedback signal in the feedback signal-generating portion will be described hereinafter with reference to FIGS. 12A to 12C.

FIG. 12A is a graphical representation showing a relationship between a pulse count in the pulse sensor of the motor, and the load detected in the load detecting portion.

As shown in FIG. 12A, the load detected in the load inputting portion 208 is approximately constant in the multiple disc clearance region B. In FIG. 12A, the load when the output shaft 181a of the motor 181 is located in a position of a starting point and a pulse count is set as zero is indicated as V0, the load when the pulse count is set as a reference value d in the torque control region C is indicated as V1, the load detected in the multiple disc clearance region B is indicated as V2, and the pulse count in the boundary between the multiple disc clearance region B and the torque control region C is indicated as a state (d−p) obtained by subtracting the pulse count from the reference value d by a predetermined value p.

FIG. 12B is a graphical representation showing a relationship between the pulse count in the pulse sensor and the load represented by a false signal generated in the feedback signal-generating portion.

As shown in FIG. 12B, the feedback signal-generating portion 210 generates the false signal a value on which changes with the rotation displacement in the multiple disc clearance region B in accordance with the rotation displacement of the output shaft 181a. Here, in FIG. 12B, the case where the rotation displacement and the output value of the false signal show a linear relationship in the multiple disc clearance region B is exemplified. However, the rotation displacement and the output value of the false signal may show a non-linear relationship in the multiple disc clearance region B. In brief, the setting may be made so that the output value increases (decreases) along with an increase (decrease) in rotation displacement of the output shaft 181a. Here, the output value of the false signal shows zero in the torque control region C.

FIG. 12C is a graphical representation showing a relationship between the pulse count in the pulse sensor of the motor and the load represented by the feedback signal outputted from the feedback signal-generating portion.

The feedback signal-generating portion 210 generates the feedback signal shown in

FIG. 12C by adding the load represented by the false signal and shown in FIG. 12B to the load shown in FIG. 12A and represented by the signal inputted thereto from the load inputting portion 208. As a result, as shown in FIG. 12C, the feedback signal changes with the rotation displacement in the multiple disc clearance region B as well. That is to say, the ECU 12 controls the motor 181 in accordance with the load detected in the load detecting portion 190 with respect to a position where the movement member 160 contacts the multiple disc clutch 150, and controls the motor 181 in accordance with the displacement detected in the pulse sensor 184 with respect to a position where the movement member 160 is separated apart from the multiple disc clutch 150.

When a signal representing the load V1 is inputted thereto from the load detecting portion 190 in the torque control region C, the feedback signal-generating portion 210 proofreads the count in the pulse sensor 184 of the motor 181 as the reference value d. As a result, the rotation displacement of the output shaft 181a detected in the pulse sensor 184 is adjusted for the load detected in the load detecting portion 190. Also, when being subtracted from the state of the reference value d by the predetermined value p, the pulse count is located in the boundary position between the multiple disc clearance region B and the torque control region C. Hence, the boundary position recognized in the pulse sensor 184 is prevented from shifting from the boundary position recognized in the load detecting portion 190.

In addition, as shown in FIG. 11, the ECU 12 has a load proofreading portion 211 for performing proofreading for the load detecting portion 190. The load proofreading portion 211 performs the proofreading when the engine is started, for example, when a power source is turned on for the vehicle or when the engine is started. More specifically, the load proofreading portion 211 rotates the motor 181 in direction along which the movement member 160 is separated apart from the multiple disc clutch 150 so that the rotation displacement of the output shaft 181a enters the sensor clearance region A. The load proofreading portion 211 produces a state in which no load is exerted on the load detecting portion 190 in the manner described above, and performs the proofreading with the value detected in this state as zero.

In addition, the load proofreading portion 211 performs the proofreading in the phase as well of the operation of the vehicle. More specifically, when the rotation displacement of the output shaft 181a enters the multiple disc clearance region B in the phase of the control in the 4WD auto mode, the load proofreading portion 211 performs the proofreading with the value detected at this time as the above-mentioned load V2. In general, in a sensor for outputting a signal representing a high or low voltage in correspondence to the large or small load, an output signal increases or decreases by a predetermined voltage value due to the dispersion in products, the change with passage of time, the temperature change, and the like. Thus, although the output signal is offset by the predetermined load due to the temperature change and the like even after the vehicle is started, the proofreading is performed in accordance with load V2, thereby realizing the more precise load detection.

Note that, the constituent elements of the ECU 12 are realized in an arbitrary combination of the hardware and the software by using a CPU, a memory, a program for realizing the individual constituent elements, a memory unit for storing therein the program, and an interface for external connection as the main constituent elements. Also, it is understood by those skilled in the art that there are various changes in its realization method and unit. FIG. 11 shows the blocks not in the form of the hardware, but in the form of the functions.

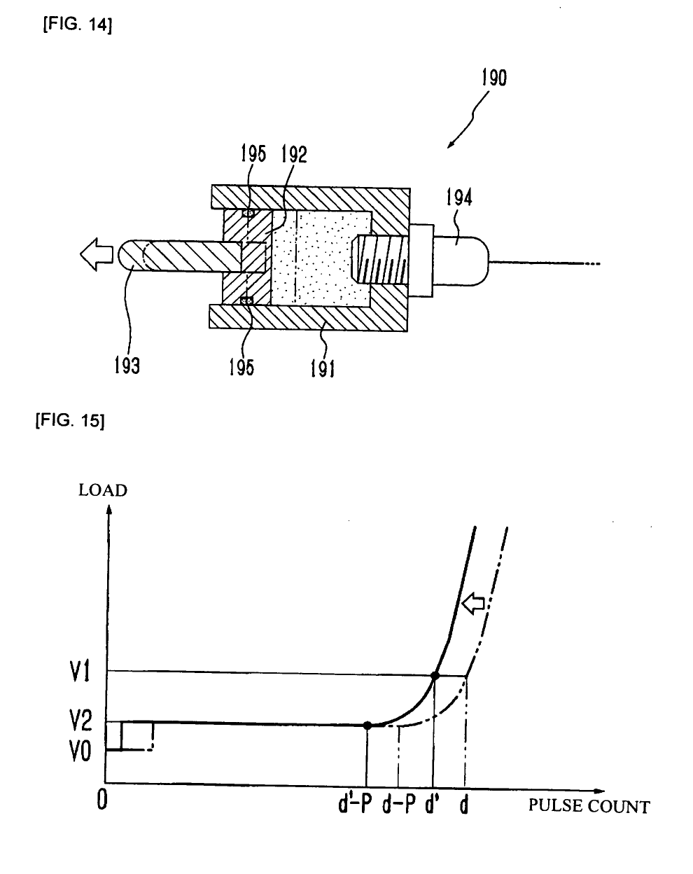

Here, the control for the transfer case 5 made by the ECU 12 will now be described with reference to a flow chart shown in FIG. 13.

When the power source is turned on for the vehicle (Step S1), the proofreading is performed for the state in which the load detected in the load detecting portion 190 is zero in the sensor clearance region A (Step S2). After that, the motor 181 is driven and the proofreading is then performed for the load V2 in the multiple disc clearance region B (Step S3). Moreover, the count in the pulse sensor 184 is proofread so that the load larger than the load V2 is detected in the load detecting portion 190 (Step S4). Thereafter, it is discriminated whether or not the power source for the vehicle is in the off state (Step S5). When it is discriminated that the power source is in the off state, the control is completed.

On the other hand, when it is discriminated that the power source for the vehicle is not in the off state (it is in the on state), subsequently, it is discriminated whether or not the mode the data on which is inputted through the operation switch 13 is the 2WD mode (Step S6). When it is discriminated that the mode concerned is the 2WD mode, the 2WD mode control is performed in which no connection force is generated in the multiple disc clutch 180 (Step S7). In the phase of the 2WD mode control, the slidable contact of each of the plates 151 and 152 is preferably prevented from occurring in the multiple disc clutch 150. Here, while not especially shown in FIG. 13, when the load changes so as to straddle the load V2 in the phase of the proceeding to the 2WD mode, at this time, the counter of the pulse sensor 184 is proofread. In addition, while not especially shown in FIG. 13, after the rotation displacement of the output shaft 181a enters the multiple clearance region B, the load V2 is proofread with a given period.

When it is discriminated in Step S6 that the mode concerned is not the 2WD mode, subsequently, it is discriminated whether or not the mode concerned is the 4WD lock mode (Step S8). When it is discriminated that the mode concerned is the 4WD lock mode, the 4WD lock mode control is performed in which the connection force of the multiple disc clutch 150 becomes maximum (Step S9). Here, while not especially shown in FIG. 7, when the load changes so as to straddle the load V2 in the phase of the proceeding to the 4WD lock mode, at this time, the counter of the pulse sensor 134 is proofread.

When it is discriminated in Step S8 that the mode concerned is not the 4WD lock mode, the 4WD auto mode is performed in which the pressure detected in the pressure sensor 194 gets a value corresponding to the connection force arithmetically operated in correspondence to the vehicle state (Step S10). Note that, while not especially shown in FIG. 13, when the load changes so as to straddle the load V1 in the phase of the proceeding to the 4WD lock mode, at this time, the counter of the pulse sensor 184 is proofread. In addition, while not especially shown in FIG. 13, when the rotation displacement of the output shaft 181a enters the multiple disc clearance region, the load V2 is proofread. After completion of processing in Step S7, Step S9 and Step S10, the operation returns back to the processing in Step S5, and the processing in Steps S5 to S10 is repeatedly executed until the power source for the vehicle becomes the off state.

According to the transfer case 5 constructed in the manner described above, since the load exerted on the second cam plate 173 of the transmission mechanism 170 for generating the connection force in the multiple disc clutch 150 is detected, the connection force of the multiple disc clutch 150 can be detected irrespective of the size errors and the assembly errors, the temperature changes and the like of the parts. Also, sine the feedback control is performed for the motor 181 in accordance with the load generated in the second cam plate 173, the torque distributed to the front drive shaft 6 can be controlled as desired.

That is to say, the transfer case is prevented from being influenced by a change in expansion and contraction, an amount of elastic deformation, and the like of the parts due to the positional shifts and the temperature changes in parts caused by the size errors, the assembly errors and the like as in the conventional one for performing the feedback control for the motor by detecting the positions, the displacements and the like of the parts of the conversion mechanism. As a result, there is no possibility that when the target torque transmitted to the front drive shaft 6 is maximum, the output shaft of the motor is further rotated than is needed, thereby generating the excessive load in each of the parts disposed around the transmission mechanism 170 and the multiple disc clutch 150 as in the conventional transfer case. As a result, the strength, the durability and the like which are required for the parts disposed around the transmission mechanism 170 and the multiple disc clutch 150 can be reduced, and thus the simplification, the thin make and the like of the constructions of the parts can be realized. Consequently, the weight-lightening and the miniaturization of the parts disposed inside the transfer case 5 can be realized. Thus, the transfer case 5 is very advantageous for a practical application.

In addition, since the second cam plates 173 outputs the load which is linear with respect to the connection force of the multiple disc clutch 150 to the load detecting portion 190, the feedback control using the load can be simply and readily performed.

In addition, since the transmission mechanism 170 has a pair of cam plates 172 and 173, and the ball 174 interposed between the cam plates 172 and 173, the driving force of the motor 181 is continuously and smoothly transmitted to the movement member 160. Therefore, the transfer case 5 is suitable for the precise control for the multiple disc clutch 150.

In addition, since the speed is reduced by the pinion gear 171 and the first cam plate 172, the torque generated in the motor 181 can be amplified and also the resulting torque can be transmitted to the first cam plate 172. Moreover, the grooves 172b and 173b circumferentially change in their depths at the given rates, respectively, which results in that the axial displacement of the first cam plate 172 is linear with respect to the rotation displacement of the output shaft 181a of the motor 181. Therefore, the displacement control for the movement member 160 is simply and readily performed.

In addition, since the load exerted on the second cam plate 173 is converted into the pressure and the resulting pressure is detected, it is possible to use the relatively inexpensive pressure sensor 194 which is hardly influenced by the temperature. Thus, the precise control becomes possible while the manufacturing cost is suppressed.

In addition, since the second cam plate 173 moves to the position where it does not contact the load detecting portion 190, this construction is convenience for the proofreading for the load detecting portion 190. Also, since the load detecting portion 190 is proofread in the phase of start of the vehicle, it is possible to proofread the error for each product of the load detecting portion 190. Also, even when the load detecting portion 190 is degraded in terms of passage of time, the proofreading can be exactly performed.

In addition, since in the phase as well of start of the vehicle, the proofreading for the load detecting portion 190 is performed in the multiple clearance region B, even when the output signal corresponding to the load detected in the load detecting portion 190 changes due to the temperature change or the like from the start of the vehicle, the precise load can be usually detected.

Also, since the motor 181 is controlled in accordance with the displacement of the output shaft 181a of the motor 181 as well as in accordance with the load detected in the load detecting portion 190 in the multiple disc clearance region B, it is possible to precisely detect the position of the starting point where the connection force is generated in the multiple disc clutch 150. In particular, since the feedback signal is made to change in the multiple disc clearance region B in accordance with the false signal in the phase of the feedback control, when the torque of the multiple disc clutch 150 changes from the torque control region C to the multiple disc clearance region B through the overshoot, it is possible to speedily return the torque back to the boundary position between the regions. Consequently, there is no hindrance even when the multiple disc clearance region B is relatively and largely ensured in which the detected load hardly changes. Thus, in the phase of the 2WD mode, the slidable contact of each of the plates 151 and 152 in the multiple disc clutch 150 can be suppressed by sufficiently separating the movement member 160 apart from the multiple disc clutch 150.

It should be noted that although the above-mentioned embodiment has shown the case of the method in which the proofreading for the load V2 is performed in the multiple disc clearance region B, the proofreading after the start of the vehicle may also be performed by combining the above-mentioned method with any other suitable one or replacing the above-mentioned method with any other suitable one. For example, a temperature sensor may be provided as a temperature detecting portion in the vicinity of the load detecting portion 190 within the transfer case 5, and the proofreading for the load detecting portion 190 and the pulse sensor 184 may be performed in accordance with an input signal sent from the temperature sensor. That is to say, a load correcting portion may be provided which corrects the load detected in the load detecting portion in accordance with the temperature detected in the temperature detecting portion and a preset map. Or, a displacement correcting portion may be provided which corrects the displacement detected in the displacement detecting portion in accordance with the temperature detected in the temperature detecting portion and the preset map. Giving the oil pressure sensing system of the above-mentioned embodiment as an example, as shown in FIG. 14, the oil enclosed in the cylinder 191 may expand or contract due to a change in environmental temperature within the case 100, so that the positions of the piston 192 and the rod 193 may shift. In this case, it is preferable that data on the detected temperature and a map of an amount of connected count are previously stored in the memory portion 207, and whenever the detected load reaches the load V1, the reference value d of the pulse counter is proofread as a new reference value d′ in accordance with the detected temperature and the map concerned. As a result, as shown in FIG. 15, the pulse count can be adjusted in accordance with the detected temperature. In this case, the reference value d of the pulse counter is preferably proofread even right after the start of the engine. The proofreading for the reference value d of the pulse counter may be performed through the averaging using the values in the phase of the past proofreading, or may be performed irrespective of the values in the phase of the past proofreading. Thus, the optimal method may be suitably selected in accordance with the specification or the like of the vehicle.

In addition, the above-mentioned embodiment has shown the case of the vehicle in which the mode concerned can be switched over to any one of the three modes having the 2WD mode, the 4WD auto mode, and the 4WD lock mode. However, the vehicle having at least the 4WD auto mode is available. For example, the vehicle may also be available in which the mode concerned, for example, can be switched over to any one of the two modes having the 4WD auto mode and the 4WD lock mode.

Also, although the above-mentioned embodiment has shown the case where the displacement of the output shaft 181a of the motor 181 is detected, for example, a displacement of the first cam plate 172 may also be detected.

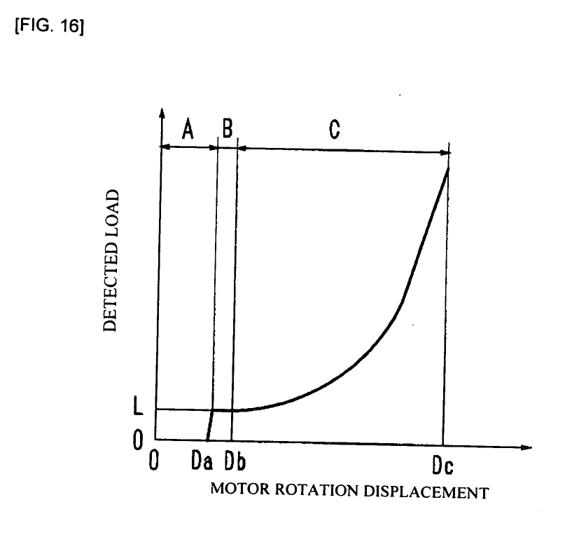

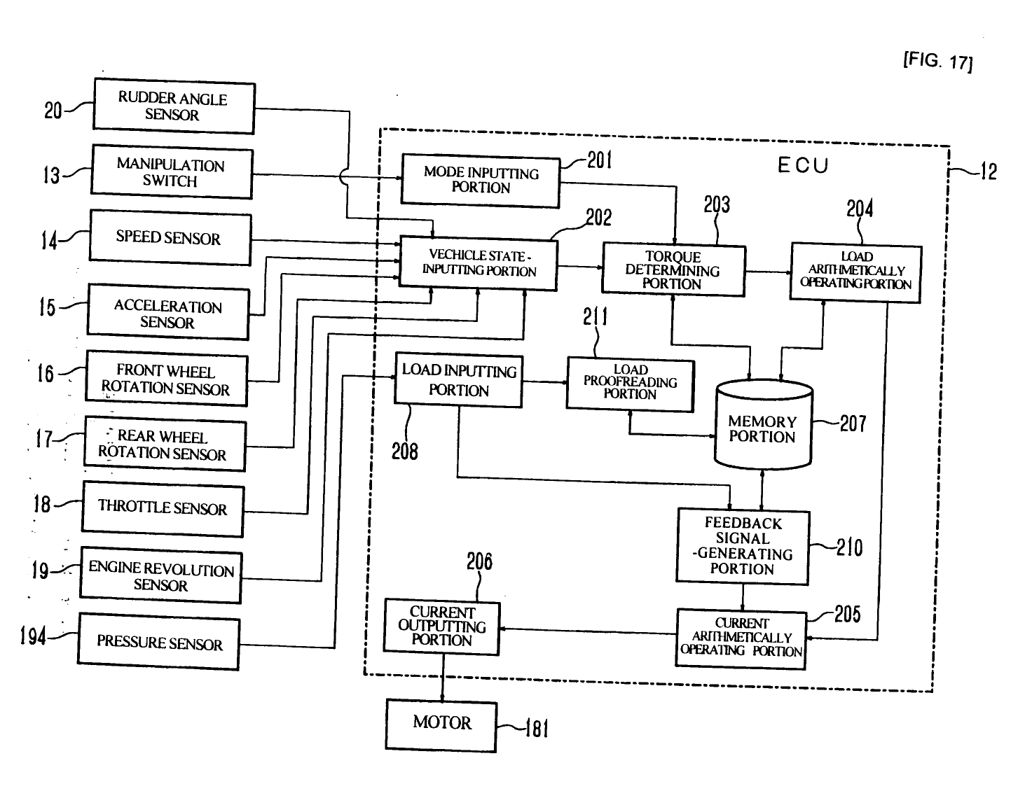

FIG. 16 is a graphical representation showing a second embodiment of the present invention, and showing a relationship between a rotation displacement of an output shaft of a motor, and a load detected in a load detecting portion in a transfer installed in a vehicle in which two modes having a 4WD auto mode and a 4WD lock mode can be switched over to each other.

In the second embodiment, since it is not necessary to consider a sliding in each of the plates 151 and 152 of the multiple disc clutch 150, a stroke of the movement member 160 which moves in the axial direction when it is separated apart from the multiple disc clutch 150 is set so as to be small and the multiple disc clearance region B of the output shaft 181a is relatively small. In this manner, in case of the multiple disc clearance region B being relatively small, it does not become a position which is separated far from the torque controlling region C by an overshoot in the multiple disc clearance region B. Thus, a control which is a relatively good response is possible without the control based on the rotation displacement of the output shaft 181a.

FIG. 17 is a schematic block diagram of an ECU of the transfer case.

In this embodiment, a pulse sensor is not provided on the motor output shaft 181a, the feedback signal-generating portion 210 outputs a signal to the current arithmetically operating portion 205 without correcting an input signal from the current arithmetically operating portion 205 as shown FIG. 6. In addition, the transfer of the second embodiment is a same constitution as the first embodiment except no 2WD mode, no pulse sensor and a smaller multiple disc clearance region.

According to the transfer case 5 constructed in the manner described above, since the load exerted on the second cam plate 173 of the transmission mechanism 170 for generating the connection force in the multiple disc clutch 150 is detected, the connection force of the multiple disc clutch 150 can be also detected irrespective of the size errors and the assembly errors, the temperature changes and the like of the parts. Also, sine the feedback control is performed for the motor 181 in accordance with the load generated in the second cam plate 173, the torque distributed to the front drive shaft 6 can be controlled as desired. As a result, the strength, the durability and the like which are required for the parts disposed around the transmission mechanism 170 and the multiple disc clutch 150 can be reduced, and thus the simplification, the thin make and the like of the constructions of the parts can be realized. Consequently, the weight-lightening and the miniaturization of the parts disposed inside the transfer case 5 can be realized. Thus, the transfer case 5 is very advantageous for a practical application.

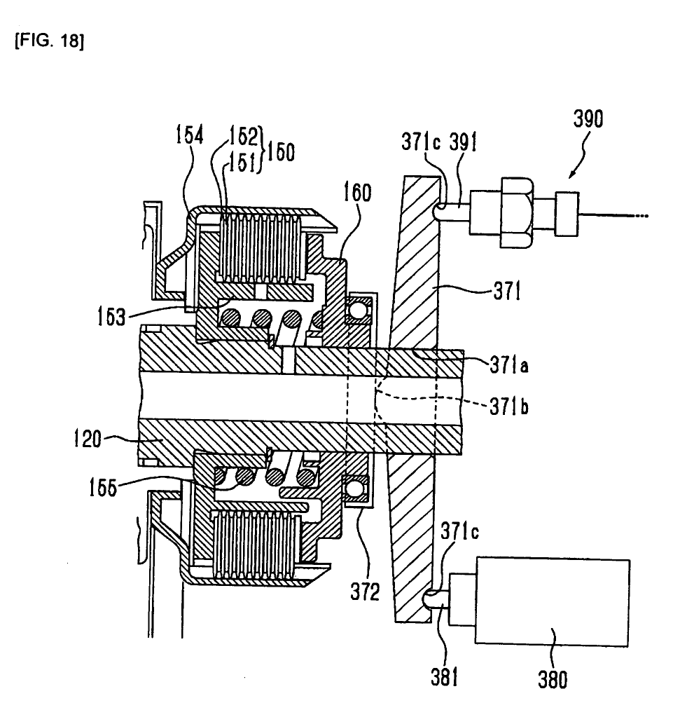

FIG. 18 is a partial explanatory cross sectional view, of a transfer case, showing a third embodiment of the present invention.

As shown in FIG. 18, this transfer case 5 has a driving portion which is constituted by a linear actuator 380 and axial movement of the movement member 160 is realized by a lever member 371 which is moved by the linear actuator 380. In this embodiment, the lever member 371 moves the movement member 160 in the axial direction.

The linear actuator 380 has a rod 381 which projects forward and moves the lever member 371 and the movement member 160 by moving the rod 381 in the axial direction. For example, the linear actuator 380 may use a solenoid or a fluid pressure. Furthermore, it may convert a rotational motion of a motor to a linear motion by a ball screw.

A load sensor 390 has a rod 391 which projects forward and output a signal related to a load to ECU 12. This load sensor 390 uses, for example, a foil gage, a semiconductor gage, or the like and directly converts a load of the rod 391 to an electric signal.

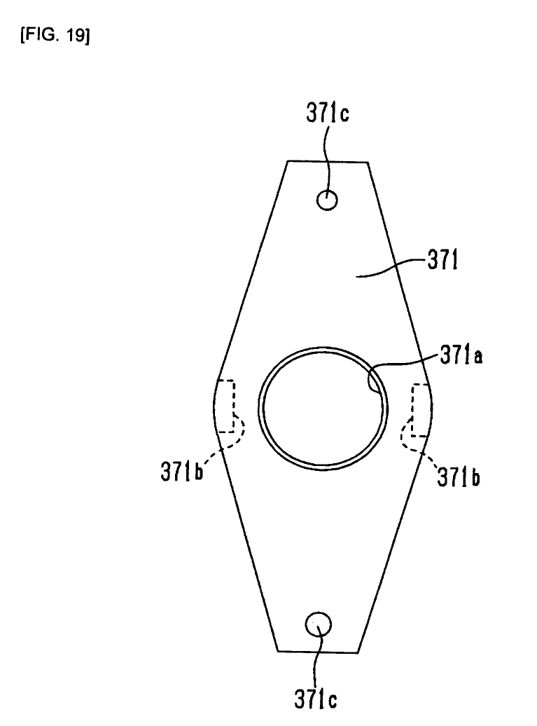

FIG. 19 is a front view of a lever member.

As shown in FIG. 19, the lever member 371 is symmetrically-formed at a vertical and a horizontal direction in the figure and a center of the lever member 371 has a insertion hole 371a which inserts the output shaft for rear wheels 120. The lever member 371 contacts a thrust needle bearing 372 at a front surface and contacts the rod 381 of the linear actuator 380 and the rod 391 of the load sensor 390 at a rear face. The lever member 371 has a pair of projection portions 371b which contact the thrust needle bearing 372 at the front surface and has a pair of reception portions 371c which receive each of rods 381, 391 at the rear surface.

In the third embodiment, a feedback control of the linear actuator 380 is performed by detecting an axial load on the lever member 371 at the load sensor 390. In this manner, it is possible to detect the connection force of the multiple disc clutch 150 and the linear load by detecting the load of the member between the driving portion and the movement portion

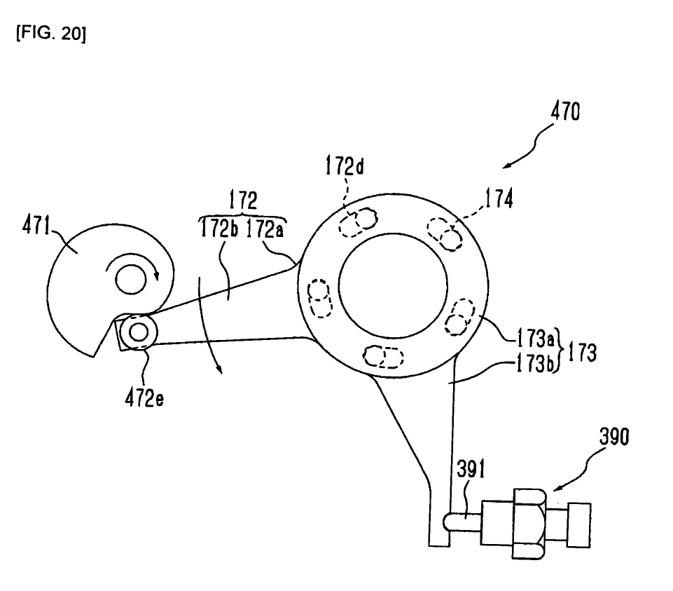

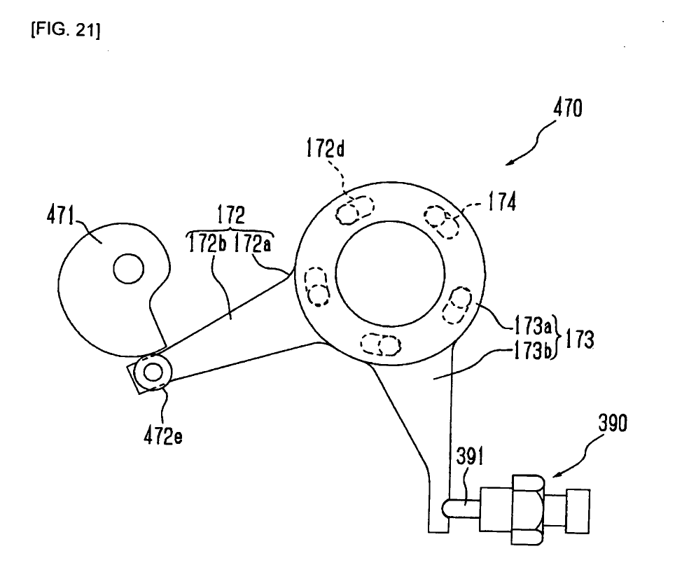

FIG. 20 and FIG. 21 are a schematic explanatory front view, of a first cam plate and a second cam plate, and parts relating thereto, showing a fourth embodiment of the present invention. FIG. 20 is showing a positional relationship among the parts in a multiple disc clearance region and FIG. 21 is showing a positional relationship among the parts in a torque control region.

In the embodiment, a constitution of a transmission mechanism 470 is different from the first embodiment. As shown in FIG. 20 and FIG. 21, the transmission mechanism 470 has the first cam plate 172 and the second cam plate 173 as well as the first embodiment, and a cam member 471 which is provided on the output shaft 182a of the speed reducer 182. A cam follower 472e is provided at the driven portion 172b of the first cam plate 172 which contacts slidably to the cam member 471 and a rotation position of the first cam plate 172 is determined by a radial measure of the cam member 471. The cam member 471 is formed like a plate and the radial measure continuously changes in a circumferential direction. In this embodiment, a circumferential measure is nonlinear with respect to a rotation angular of the output shaft 181a in the motor 181.

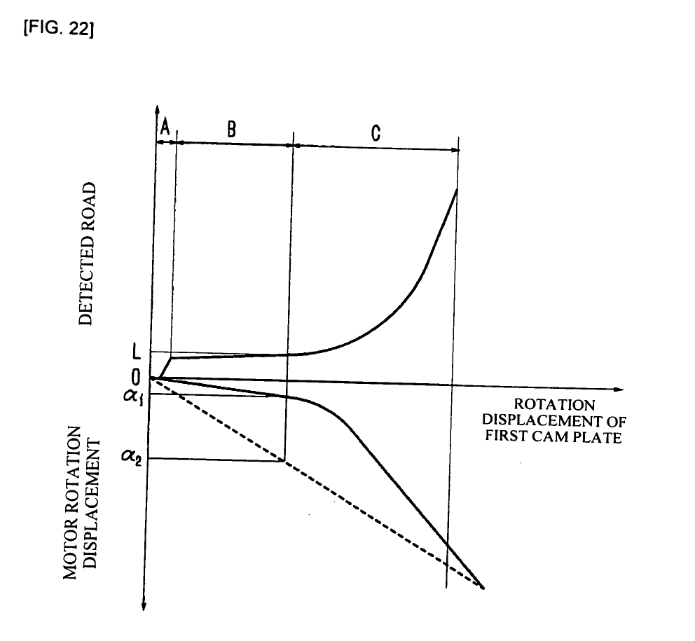

FIG. 22 is a graphical representation in which its upper side is a graphical representation showing a relationship between a rotation displacement of the first cam plate, and a load detected in a load detecting portion, and its lower side is a graphical representation showing a relationship between the rotation displacement of the first cam plate, and a rotation displacement of an output shaft of a motor.

As shown in FIG. 22, a shape of the cam member 471 is determined so as to increase an angular variation in the first cam plate 172 per an unit angular of the output shaft 181a in the sensor clearance region A and the multiple disc clearance region B. Here, “increasing angular variation” means that the angular variation is bigger than the expected one in which the angular variation in the first cam plate 172 per the unit angular of the output shaft 181a is constant. As shown in FIG. 22, if the angular variation per the unit angular is constant, a rotation displacement of the output shaft 181a is α2, but it is α1 smaller than α2 in this embodiment. In this embodiment, the angular variation in the first cam plate 172 per the unit angular of the output shaft 181a also increases at a small load region in the torque control region C. As shown in FIG. 22, the angular variation in the first cam plate 172 per the unit angular of the output shaft 181a decreases at a big load region in the torque control region C.

According to the constitution in the manner described above, in the multiple disc clearance region B, since the angular variation in the first cam plate 172 per the unit angular of the output shaft 181a is increased, a travel distance of the movement member 160 per the unit angular of the output shaft 181a can be increased in the multiple disc clearance region B. In this manner, at the time of switching from the 2WD mode to the 4WD auto mode or the 4WD lock mode, since it can rapidly generate a connection force in the multiple disc clutch 150, the switching response of each of the modes can be quick.

Also, in the small load region in the torque control region C, since the angular variation in the first cam plate 172 per the unit angular of the output shaft 181a is increased, a travel distance of the movement member 160 per the unit angular of the output shaft 181a can be increased in said region. In this manner, in the small load region in the torque control region C, this region is often used at the time of 4WD auto mode, it is very advantageous for a practical application since the switching response can be quick.

It should be noted that although the fourth embodiment has shown the case of the device in which the rotation angular of the output shaft 181a of the motor 181 and the rotation angular of the first cam plate 172 are nonlinear, these may also be linear.

Also, it should be noted that although the first to the fourth embodiment have shown the case of the transfer case 5 in which the motive power is always transmitted to the rear wheel 11 side and the torque is distributed to the front wheel 9 side as necessary, the motive power may be always transmitted to the front wheel 9 side. Furthermore, although the control of the multiple disc clutch 150 for the transfer case 5 has shown, a motion transmission mechanism, of a differential gear or the like, may be accordingly modifiable. Also, it has shown the one mounted on the automobile vehicle, the one mounted on the vehicle of, for example, a railcar may be applicable. Furthermore, a working machine or the like may be applicable.

Also, for example, a roller is usable for the conversion mechanism instead of using the ball, and it stands to reason that other concrete detail structure or the like may be accordingly modifiable.

### INDUSTRIAL APPLICABILITY

The present invention may have applicability to a device which includes a multiple disc clutch for a power transmission or a control. For example, it may have applicability to a vehicle of an automobile, a railcar, or the like, various industrial machine, various working machine, or the like.

1. A controller for a multiple disc clutch, including:
a multiple disc clutch having a plurality of clutch plates;
a movement member for contacting the multiple disc clutch to adjust a connection force of the multiple disc clutch, the movement member being movable in an arrangement direction of the plurality of clutch plates;
a driving portion for moving the movement member in the arrangement direction;
a transmission portion which transmits a driving force of the driving portion to the movement member, is subjected to a force in the arrangement direction in a phase of connection of the multiple disc clutch, and has a loaded member being subjected to a load linear with respect to the connection force of the multiple disc clutch in a predetermined direction;
a load detecting portion for detecting the load exerted on the loaded member in the predetermined direction; and
a control portion for controlling the driving portion in accordance with the load detected in the load detecting portion.

2. The controller for a multiple disc clutch according to claim 1, wherein the driving portion is an actuator which generates a driving force in a rotation direction, and wherein the transmission portion converts a motion of the actuator in rotation direction to a motion of the movement member in the arrangement direction, and wherein the loaded member is subjected to a load in a rotation direction and the arrangement direction in the phase of connection of the multiple disc clutch.

3. The controller for a multiple disc clutch according to claim 2, wherein the loaded member has a groove portion which is a changing depth and formed on the surface of the loaded member, and wherein the transmission portion has an intermediate member which is provided between the loaded member and the movement member and has a groove portion formed on the surface of the intermediate member, and a ball which is interposed between the groove portion on the loaded member and the groove portion on the intermediate member, and wherein the load detection portion detects a load of the loaded member in the rotation direction.

4. The controller for a multiple disc clutch according to claim 3, wherein the transmission portion has a pinion gear which is provided on an output shaft of the actuator and drives the intermediate member in a rotation direction.

5. The controller for a multiple disc clutch according to claim 3, wherein the transmission portion has a cam member which is provided on an output shaft of the actuator and drives the intermediate member in a rotation direction.

6. The controller for a multiple disc clutch according to claim 1, wherein the driving portion generates a driving force of the movement member in an axial direction, and wherein the transmission portion transmits a motion of the driving portion in an axial direction as a motion of the movement member in the arrangement direction, and wherein the loaded member is subjected to the force in the arrangement direction in a phase of connection of the multiple disc clutch, and wherein the load detection portion detects a load of the loaded member in the arrangement direction.

7. The controller for a multiple disc clutch according to claim 1, wherein the load detection portion has a load sensor.

8. The controller for a multiple disc clutch according to claim 1, wherein the load detection portion has a converting mechanism which converts the load of the loaded member to a fluid pressure and a pressure sensor which detects the fluid pressure.

9. The controller for a multiple disc clutch according to claim 1, wherein the controller includes a load proofreading portion which proofreads the load detection portion by moving the loaded member to a position in which a load detected by the load detection portion is zero.

10. The controller for a multiple disc clutch according to claim 9, wherein the controller includes a bias member biasing the movement member in the direction in which the movement member is separated apart from the multiple disc clutch, and wherein the load proofreading portion proofreads the load detection portion as the load detection portion is zero at a state in which the movement member is separated apart from the multiple disc clutch.

11. The controller for a multiple disc clutch according to claim 1, wherein the controller includes a temperature detecting portion which detects a temperature, a load correcting portion which corrects a detected load at the load detecting portion based on the temperature detected at the temperature detecting portion and a preset map.

12. A controller for a multiple disc clutch, including:
a multiple disc clutch having a plurality of clutch plates;
a movement member for contacting the multiple disc clutch to adjust a connection force of the multiple disc clutch, the movement member being movable in an arrangement direction of the plurality of clutch plates, the movement member being movable to a position where the movement member is separated apart from the multiple disc clutch;
a driving portion for moving the movement member in the arrangement direction;
a transmission portion which transmits a driving force of the driving portion to the movement member, is subjected to a force in the arrangement direction in a phase of connection of the multiple disc clutch, and has a loaded member being subjected to a load linear with respect to the connection force of the multiple disc clutch in a predetermined direction;
a displacement detecting portion for detecting a displacement of a link member, the link member being moved by driving of the driving portion;
a load detecting portion for detecting a load exerted on the member on which a load is to be exerted in a predetermined direction; and
a control portion for controlling the driving portion in accordance with the load detected in the load detecting portion with respect to a position where the movement member contacts the multiple disc clutch, and controlling the driving portion in accordance with the displacement detected in the displacement detecting portion with respect to a position where the movement member is separated apart from the multiple disc clutch.

13. The controller for a multiple disc clutch according to claim 12, wherein the driving portion is an actuator which generates a driving force in a rotation direction, and wherein the transmission portion coverts a motion of the actuator in rotation direction to a motion of the movement member in the arrangement direction, and wherein the loaded member is subjected to a load in a rotation direction and the arrangement direction in the phase of connection of the multiple disc clutch.

14. The controller for a multiple disc clutch according to claim 13, wherein the loaded member has a groove portion which is a changing depth and formed on the surface of the loaded member, and wherein the transmission portion has an intermediate member which is provided between the loaded member and the movement member and has a groove portion formed on the surface of the intermediate member, and a ball which is interposed between the groove portion on the loaded member and the groove portion on the intermediate member, and wherein the load detection portion detects a load of the loaded member in the rotation direction.

15. The controller for a multiple disc clutch according to claim 14, wherein the transmission portion has a pinion gear which is provided on an output shaft of the actuator and drives the intermediate member in a rotation direction.

16. The controller for a multiple disc clutch according to claim 14, wherein the transmission portion has a cam member which is provided on an output shaft of the actuator and drives the intermediate member in a rotation direction.

17. The controller for a multiple disc clutch according to claim 12, wherein the driving portion generates a driving force of the movement member in an axial direction, and wherein the transmission portion transmits a motion of the driving portion in an axial direction as a motion of the movement member in the arrangement direction, and wherein the loaded member is subjected to the force in the arrangement direction in a phase of connection of the multiple disc clutch, and wherein the load detection portion detects a load of the loaded member in the arrangement direction.

18. The controller for a multiple disc clutch according to claim 12, wherein the load detection portion has a load sensor.

19. The controller for a multiple disc clutch according to claim 12, wherein the load detection portion has a converting mechanism which converts the load of the loaded member to a fluid pressure and a pressure sensor which detects the fluid pressure.

20. The controller for a multiple disc clutch according to claim 12, wherein the controller includes a load proofreading portion which proofreads the load detection portion by moving the loaded member to a position in which a load detected by the load detection portion is zero.

21. The controller for a multiple disc clutch according to claim 20, wherein the controller includes a bias member biasing the movement member in the direction in which the movement member is separated apart from the multiple disc clutch, and wherein the load proofreading portion proofreads the load detection portion as the load detection portion is zero at a state in which the movement member is separated apart from the multiple disc clutch.

22. The controller for a multiple disc clutch according to claim 12, wherein the controller includes a temperature detecting portion which detects a temperature, a load correcting portion which corrects a detected load at the load detecting portion based on the temperature detected at the temperature detecting portion and a preset map.

23. The controller for a multiple disc clutch according to claim 12, wherein the controller includes a temperature detecting portion which detects a temperature, a load correcting portion which corrects a detected displacement at the displacement detecting portion based on the displacement detected at the displacement detecting portion and a preset map.

24. A transfer case, including:
an input shaft;
a first output shaft and a second shaft, a motive power of the input shaft being transmitted to each of the first output shaft and the second shaft; and
a controller for the multiple disc clutch according to claim 1, for controlling a distribution of the motive power transmitted from the first input shaft to each of the first output shaft and the second output shaft.

25. A transfer case, including:
an input shaft;
a first output shaft and a second shaft, a motive power of the input shaft being transmitted to each of the first output shaft and the second shaft; and
a controller for the multiple disc clutch according to claim 12, for controlling a distribution of the motive power transmitted from the first input shaft to each of the first output shaft and the second output shaft.
